(19) United States
(12) Patent Application Publication
(10) Pub. No.: US 2007/0287787 A1
(43) Pub. Date: Dec. 13, 2007

(54) Hybrid Adhesive

(75) Inventor: Damien Ferrand, Sierentz (FR)

Correspondence Address: SHOEMAKER AND MATTARE, LTD, 10 POST OFFICE ROAD - SUITE 110, SILVER SPRING, MD, 20910, US

(73) Assignee: COLLANO AG, Sempach-Station (CH)

(21) Appl. No.: 11/759,516

(22) Filed: Jun. 7, 2007

(30) Foreign Application Priority Data
Jun. 12, 2006 (EP) 06115326.8

(51) Int. Cl. C08K 3/34; B60C 1/00

(52) U.S. Cl. 524/492

(57) ABSTRACT

The invention relates to a hybrid adhesive comprising a silane resin and an epoxy resin, further comprising (a) at least one nonaromatic tertiary diamine or polyamine, selected in particular from the group consisting of aliphatic amines, cycloaliphatic amines, amidoamines, and mixtures thereof; and (b) at least one silane catalyst which is not an amine compound, being more particularly an organometallic compound, preferably selected from the group consisting of organotin compounds, organozirconate compounds, organotitanate compounds, and mixtures thereof. The hybrid adhesive is suitable for application to vertical surfaces and is of outstanding light transmittance.

The invention relates to the field of hybrid adhesives, more particularly silane/epoxy hybrid adhesives.

Hybrid adhesives are reactive adhesives which cure by at least two chemically different reaction mechanisms. In these systems two different polymer resins are employed, and hence they are also referred to as polymer alloys. In the case of a silane/epoxy hybrid adhesive a silane-functionalized resin is combined with an epoxy resin, more particularly 2K (2-component) epoxy resins. The highly elastic, flexible and tough properties of a silane adhesive can be combined in such hybrid adhesives with the high-strength but brittle properties of an epoxy adhesive. In hybrid adhesives of this kind, in the cured state there are epoxide particles (hard domains) embedded in a silane-crosslinked matrix. Tensile stress and breaking elongation of silane/epoxy hybrid adhesives are such that they close the gap that exists in this respect in adhesive technology between silicones and 2K PU structural adhesives in a particularly appropriate way (cf., e.g., Damien Ferrand, Willi Schwotzer in Adhesives & Sealants Industry magazine, BNP Media, http://www.adhesivesmag.com, April 2004; and Christian Terfloth, “Automotive Circle International” Conference, 17/18 Oct. 2002, pp. 33-42).

In terms of light transmittance and capacity for application to vertical surfaces, however, the properties of the known silane/epoxy hybrid adhesives are still not optimal. In many cases, as for example that of application to glass surfaces, a very high light transmittance of the adhesive is desirable, as is a rheology that is appropriate for vertical applications.

The product Collano A8 6400, although having the desired transparency, is nevertheless unsuitable for vertical application, owing to the rheology.

The product presented in “Automotive Circle International” Conference, 17/18 Oct. 2002, pp. 33-42 (see above) ought to be suitable for vertical application, on account of the very high viscosity of 500 Pa*s, but has a dark gray color and is therefore not suitable for applications on glass, for example.

It is an object of the present invention, therefore, to provide a silane/epoxy hybrid adhesive which not only ensures high light transmittance but also combines a rheology suitable for vertical application with sufficient Shore A hardness and tensile strength.

This object is achieved by means of the hybrid adhesive of the invention.

The hybrid adhesive of the invention has a silane resin and an epoxy resin and further comprises

at least one nonaromatic, tertiary diamine or polyamine, selected in particular from the group consisting of aliphatic amines, cycloaliphatic amines, amidoamines, and mixtures thereof; and

at least one silane catalyst which is not an amine compound, being more particularly an organometallic compound, preferably selected from the group consisting of organotin compounds, an organozirconate compounds, organotitanate compounds, and mixtures thereof.

By a silane resin are meant here polymers whose backbone is formed from a polymer, in particular a polyurethane, silicone, polyether or polyolefin, which has been modified with siloxane groups. Particularly preferred on account of their reactivity are the methoxysilanes, which crosslink under the effect of moisture:

2(CH₃O)ₘ(CH₃)ₙSi—R—Si(OCH₃)ₘ(CH₃)ₙ+H₂O→(CH₃O)ₘ(CH₃)ₙSi—R—Si(OCH₃)ₘ₋₁(CH₃)ₙ—O—Si(OCH₃)ₘ₋₁(CH₃)ₙ—O—Si(OCH₃)ₘ(CH₃)ₙ+2CH₃OH

(where m=3, 2, 1; n=0, 1, 2; m+n=3)

Silane resins particularly preferred in the context of the present invention are silane-terminated polyurethanes (e.g., Baycoll® XP 2458, based on a polyether polyol) and reactants capable of forming a silane-terminated polyurethane. Suitable reactants are known to the skilled worker (examples being isocyanate-terminated polyether polyols and aminosilanes such as Dynasylan® DAMO-T, for example).

In customary practice the silane crosslinking is catalyzed in particular by organometallic catalysts, preferably tin catalysts, or by amines, which have been found outstandingly suitable; suitable in principle, however, are all Brønsted/Lewis acids and bases which are suitable for catalyzing the rate-determining step, the hydrolysis of the silane ester. In a silane/epoxy hybrid adhesive the use of an amine catalyst would be particularly preferable, since it also catalyzes the epoxide crosslinking:

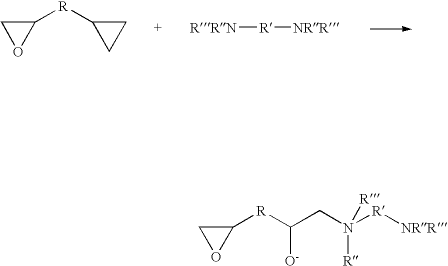

The aromatic amines that are actually preferred on account of their higher reactivity, however, have the effect—intolerable in the present case—of giving rise to discolorations which disrupt the optical impression. In the present invention, therefore, nonaromatic amine catalysts are employed. A nonaromatic amine catalyst, however, has on its own not been found suitable for producing, in a thickened hybrid adhesive, such complete crosslinking that the desired Shore A hardness of ≧60, preferably of ≧65, more preferably of ≧70 is achieved in the cured state. It has been found that the inadequate Shore A hardness is attributable to incomplete crosslinking of the silane fraction. In the present invention, therefore, a further silane catalyst is employed which is not an amine compound. Particularly preferred silane catalysts are organotin compounds.

A further aspect of the present invention relates to achieving a firmness such that, following application in a thickness of approximately 1 mm, preferably approximately 2 mm, more preferably approximately 3 mm to a vertical surface of HVG-DGG (Hüttentechnische Vereinigung der deutschen Glas-industrie e.V., Deutsche Glastechnische Gesellschaft e.V.) standard glass I, the hybrid adhesive does not run. It would easily be possible to add a multiplicity of fillers if the only consideration was that of achieving such a firmness. However, it was necessary to find a filler that did not significantly hinder the transparency or light transmittance.

A component which emerged as being particularly advantageous was a hydrophobic fumed silica, more particularly a hexamethyldisilazane-modified fumed silica, which has a specific surface area (BET) of ≧160 m²/g, preferably of ≧200 m²/g, more preferably of ≧240 m²/g. Products of this kind are available commercially, for example under the trade name Aerosil® R 812 (Degussa AG).

In particularly preferred embodiments a hybrid adhesive of this kind exhibits substantially no discoloration and/or clouding of the adhesive when stored under air ingress conditions at 70° C. for 24 hours.

Suitable nonaromatic polyamines are familiar to the skilled worker. Particularly preferred for use as constituent (a) is a nonaromatic polyamine selected from the group consisting of DABCO (1,4-diaza-bicyclo[2.2.2]octane), DBU (1,8-diazabicyclo[5.4.0]-undec-7-ene, DBN (1,5-diazabicyclo[4.3.0]non-5-ene), 7-methyl-1,5,7-triazabicyclo[4.4.0]dec-5-ene, 1,2,2,6,6-pentamethylpiperidine, N,N-diisopropyl-3-pentylamine, N-ethyldiisopropylamine, 2-tert-butyl-1,1,3,3-tetra-methylguanidine, N,N′-dimethylpiperazine, 1,8-diaza-bicyclo[5.4.0]under-7-ene, and mixtures thereof.

Particularly preferred as constituent (a) is 1,8-diazabicyclo[5.4.0]-undec-7-ene, available under the trade name Lupragen N700 (BASF):

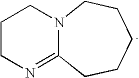

Particularly preferred embodiments use as constituent (b) an organotin compound selected from the group consisting of dioctyltin di(2-ethylhexanoate) solution, dioctyltin dilaurate, dioctyltin oxide, dibutyltin dilaurate, dibutyltin dicarboxylate, butyl-tin tris (2-ethylhexanoate), dibutyltin dineodecanoate, laurylstannoxane, dibutyltin diketanoate, dioctyltin oxide, dibutyltin diacetate, dibutyltin maleate, dibutyltin dichloride, dibutyltin sulfide, dibutyltin oxide, butyltin dihydroxychloride, butyltin oxide, dibutyltin dioctylmaleate, tetrabutyltin, zinc ricinoleate, zinc octoate, zinc acetylacetonate, zinc oxalate, and mixtures thereof.

The organozirconate or organotitanate compounds which can be employed alternatively or supplementarily are familiar to the skilled worker and are available, for example, from DuPont under the brand name Tyzor®.

Used with particular preference as constituent (b) is laurylstannoxane, [(C₄H₉)₂Sn(OOCC₁₁H₂₃)]₂O, which is available commercially (Tegokat® 225, Goldschmidt TIB GmbH, Mannheim, Germany).

In particularly preferred embodiments the hybrid adhesive of the invention in the cured state has a tensile strength to DIN 53455 (aluminum) of ≧7 MPa, preferably of ≧8 MPa, more preferably of ≧9 MPa. In the prior art, silane-terminated polyurethane resins and silane-terminated polyethers are considered equivalent in their usefulness. Now, however, it has been found that silane-terminated polyurethane resins, particularly those based on polyether polyols, are able in the context of the present invention to ensure a tensile strength which is superior to that obtained using silane-terminated straight polyethers.

The present hybrid adhesive is preferably a 2-component adhesive, which may be offered, for example, in typical dual cartridges or suitable tubular pouches. In these cases the nonaromatic polyamine and the silane catalyst will be present preferably in separate components. Given appropriate deactivation or encapsulation of one reactive constituent, the epoxide for example, however, the presentation of the hybrid adhesive of the invention in a 1K (1-component) form is also conceivable.

As set out above, there should be very little adverse effect on the transparency of the adhesive. With particular preference, the hybrid adhesive of the invention in the cured state, along a path length of 1 mm, backed with a BaSO₄ background (Ulbricht sphere), has a light transmittance in the visible region of ≧30%, preferably of ≧40%, more preferably of ≧50%.

A further aspect of the invention therefore relates to the use of a catalyst combination comprising

at least one nonaromatic tertiary diamine or polyamine selected in particular from the group consisting of aliphatic amines, cycloaliphatic amines, amidoamines and mixtures thereof; and

at least one silane catalyst which is not an amine compound, being more particularly an organometallic compound, preferably selected from the group consisting of organotin compounds, organozirconate compounds, organotitanate compounds, and mixtures thereof; to avoid discoloration and/or clouding in adhesives, particularly in the hybrid adhesives described above.

The invention is illustrated below with reference to a specific exemplary embodiment, without any intention that the invention should be restricted to this embodiment. An exemplary 2-component hybrid adhesive has the following composition:

| | Amoung in g per kg | Proportion |
|---|---|---|
| Constituent | of total composition | in % |
| in component A: | | |
| Baycoll XP 2458 (¹) | 838.490 | 83.860 |
| Kaneka SAT 10 (²) | 93.140 | 9.310 |
| Aerosil ® R 812 (³) | 30.710 | 3.070 |
| Tinuvin 770 (⁴) | 2.230 | 0.223 |
| Irganox 1010 (⁵) | 2.640 | 0.264 |
| Dynasylan ® VTMO (⁶) | 4.050 | 0.405 |
| Dynasylan ® DAMO-T (⁷) | 20.470 | 2.050 |
| Lupragen N700 (⁸) | 7.670 | 0.770 |
| Baysilone Antifoam 100% (⁹) | 0.512 | 0.051 |
| Total, Comp. A | 999.912 | 100.003 |
| in component B: | | |
| Polypox E 411 (¹⁰) | 443.240 | 88.650 |
| Aerosil ® R 812 (³) | 31.750 | 6.350 |
| Edenor C12 (¹¹) | 2.320 | 0.464 |
| Tegokat 225 (¹²) | 3.400 | 0.680 |
| Water, deion. | 4.640 | 0.928 |
| Baysilone Antifoam 100% (⁹) | 0.460 | 0.092 |
| Polypox R 20 (¹³) | 2.850 | 0.570 |
| 0.1% Sandoplast Blue 2B (¹⁴) in 100 g | 11.340 | 2.270 |
| Polypox E 411 | | |
| Total, Comp. B | 500.000 | 100.004 |

As to the constituents used:
(¹) : silane-terminated polyurethane, viscosity 35 Pa*s (Bayer MaterialScience);
(²) : short-chain, silyl-terminated polyether (Kaneka Corp.);
(³) : fumed silica (Degussa AG);
(⁴) : UV stabilizer (Ciba Specialty Chemicals);
(⁵) : antioxidant (Ciba Specialty Chemicals);
(⁶) : vinyltrimethoxysilane (Degussa);
(⁷) : N-(2-aminoethyl)-3-aminopropyltrimethoxysilane (Degussa);
(⁸) : 1,8-diazabicyclo[5.4.0]undec-7-ene (BASF)

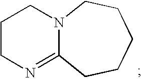

(⁹) : polyether-modified methylpolysiloxane (Borchers GmbH);
(¹⁰) : low-viscosity, low-crystallization epoxy resin based on bisphenol A (UPPC AG);
(¹¹) : lauric acid (Cognis);
(¹²) : laurylstannoxane, [(C₄H₉)₂Sn(OOCC₁₁H₂₃)]₂O (Gold-schmidt TIB);
(¹³) : epoxy diluent (UPPC AG)

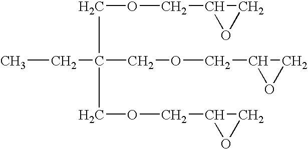

which can be utilized (optionally) for adjusting the viscosity and flow properties;
(¹⁴) : anthraquinone dye (Clariant) . This dye was added in the exemplary embodiment in order to adapt the perceived color to the coloring of a defined glass flank. The dye can readily be omitted in order to obtain a colorlessly transparent adhesive.

The Aerosil® as well was selected in particular in the above example to have a suitability such that it was possible to meet the requirements in terms both of light transmittance and of firmness: whereas it was not possible to achieve satisfactory results with Aerosils R 202, R 972, and R 8200, the aforementioned objectives were met using Aerosil R 812.

The above components A and B were mixed in an A/B ratio of 2/1 to form a hybrid adhesive of the invention and were cured (using routine measures typical in the art it is also possible to adjust the hybrid adhesive, if desired, to any other mixing ratio, for example in the range from 1:1 to 10:1 or else from 1:1-1:10). Even after 24 hours at 70° C. under air ingress conditions, no yellowing or clouding of the adhesive whatsoever was observed. The firmness of the composition is such that, following application in a thickness of approximately 1 mm to a vertical surface of HVG-DGG (Hüttentechnische Vereinigung der deutschen Glasindustrie e.V., Deutsche Glastechnische Gesellschaft e.V.) standard glass I, it does not run. The desired Shore A hardness can be set with ease in the context of the invention, by the skilled worker, in routine experiments on the selection and the amount of the catalysts, in particular of the nonaromatic diamine or polyamine.

1. Hybrid adhesive comprising a silane resin and an epoxy resin, further comprising
(a) at least one nonaromatic tertiary diamine or polyamine; and
(b) at least one silane catalyst which is not an amine compound,
further comprising a hydrophobic fumed silica which has a specific surface area of ≧160 m²/g.

2. Hybrid adhesive according to claim 1, wherein the fumed silica is a hexamethyldisilazane-modified fumed silica.

3. Hybrid adhesive according to claim 1, characterized in that its firmness is such that, following application in a thickness of approximately 1 mm, to a vertical surface of HVG-DGG (Hüttentechnische Vereinigung der deutschen Glasindustrie e.V., Deutsche Glastechnische Gesellschaft e.V.) standard glass I, it does not run.

4. Hybrid adhesive according to claim 1, characterized in that, on storage under air ingress conditions at 70° C. for 24 hours, there is substantially no discoloration and/or clouding of the adhesive.

5. Hybrid adhesive according to claim 1, characterized in that, in the cured state, it has a Shore A hardness of ≧60.

6. Hybrid adhesive according to claim 1, characterized in that use is made as constituent (a) of a nonaromatic diamine or polyamine selected from the group consisting of DABCO (1,4-diazabicyclo-[2.2.2]octane), DBU (1,8-diazabicyclo[5.4.0]undec-7-ene, DBN (1,5-diazabicyclo[4.3.0]non-5-ene), 7-methyl-1,5,7-triazabicyclo[4.4.0]dec-5-ene, 1,2,2,6,6-penta-methylpiperidine, N,N-diisopropyl-3-pentylamine, N-ethyldiisopropylamine, 2-tert-butyl-1,1,3,3-tetramethylguanidine, N,N′-dimethylpiperazine, 1,8-diazabicyclo[5.4.0]undec-7-ene, and mixtures thereof.

7. Hybrid adhesive according to claim 6, characterized in that use is made as constituent (a) of 1,8-diazabicyclo[5.4.0]undec-7-ene,

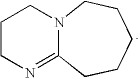

8. Hybrid adhesive according to claim 1, characterized in that use is made as constituent (b) of an organotin compound selected from the group consisting of dioctyltin di(2-ethylhexanoate) solution, dioctyltin dilaurate, dioctyltin oxide, dibutyltin dilaurate, dibutyltin dicarboxylate, butyltin tris (2-ethylhexanoate), dibutyltin dineodecanoate, laurylstannoxane, dibutyltin diketanoate, dioctyltin oxide, dibutyltin diacetate, dibutyltin maleate, dibutyltin dichloride, dibutyltin sulfide, dibutyltin oxide, butyltin dihydroxychloride, butyltin oxide, dibutyltin dioctylmaleinate, tetrabutyltin, zinc ricinoleate, zinc octoate, zinc acetylacetonate, zinc oxalate, and mixtures thereof.

9. Hybrid adhesive according to claim 8, characterized in that use is made as constituent (b) of laurylstannoxane [(C₄H₉)₂Sn(OOCC₁₁H₂₃)]₂O.

10. Hybrid adhesive according to claim 1, characterized in that the composition comprises a silane-terminated polyurethane or reactants capable of forming a silane-terminated polyurethane.

11. Hybrid adhesive according to claim 1, characterized in that it is a 1-component or 2-component adhesive.

12. Hybrid adhesive according to claim 11, characterized in that it is a 2-component adhesive in which the nonaromatic tertiary polyamine and the silane catalyst are present in separate components.

13. Hybrid adhesive according to claim 1, characterized in that, in the cured state, it has a tensile strength to DIN 53455 (aluminum) of ≧7 MPa.

14. Hybrid adhesive according to claim 1, characterized in that, in the cured state, along a path length of 1 mm, backed with a BaSO₄ background, it has a light transmittance in the visible region of ≧30%.

15. Method to avoid discoloration and/or clouding in adhesives, comprising the step of adding a catalyst combination comprising
(a) at least one nonaromatic tertiary diamine or polyamine, and
(b) at least one silane catalyst which is not an amine compound.

16. Method according to claim 15, wherein the nonaromatic tertiary diamine or polyamine is selected from the group consisting of aliphatic amines, cycloaliphatic amines, amidoamines, and mixtures thereof.

17. Method according to claim 15, wherein the silane catalyst is an organometallic compound.

18. Method according to claim 15, wherein the silane catalyst is selected from the group consisting of organotin compounds, organozirconate compounds, organotitanate compounds, and mixtures thereof.

19. Composite and/or seal produced using a hybrid adhesive according to claim 1.
